(19) United States
(12) Patent Application Publication
(10) Pub. No.: US 2022/0348520 A1
(43) Pub. Date: Nov. 3, 2022

(54) PYROTECHNIC GAS-GENERATING COMPOSITION

(71) Applicant: ARIANEGROUP SAS, LES MUREAUX (FR)

(72) Inventors: Frédéric MARLIN, LE HAILLAN (FR); Aurélien DOILLON, LE HAILLAN (FR)

(21) Appl. No.: 17/621,507

(22) PCT Filed: Jun. 23, 2020
(86) PCT No.: PCT/FR2020/051086

§ 371 Date: Dec. 21, 2021

(30) Foreign Application Priority Data
Jun. 24, 2019 (FR) FR1906803

(51) Int. Cl. C06D 5/06; A62C 35/02

(52) U.S. Cl. CPC C06D 5/06; A62C 35/023; B60R 21/2644

(57) ABSTRACT

A gas-generating pyrotechnic composition has a high gas yield while having reduced generation of condensable species and a limited combustion temperature.

### TECHNICAL FIELD

The invention relates to a pyrotechnic composition which generates a gas with a low level of condensable species and which has a limited combustion temperature. The invention also relates to devices incorporating such a pyrotechnic composition.

### PRIOR ART

Generating gas from the combustion of pyrotechnic compositions has a variety of applications, in particular for inflating airbags to protect vehicle occupants, or as a solution for pressurizing an extinguishing agent present in a tank in order to trigger its dispensing to a fire zone.

It is nevertheless desirable to improve the existing gas-generating pyrotechnic compositions by stabilizing the pressure of the gas phase produced over time while maintaining a satisfactory gas yield.

### DISCLOSURE OF THE INVENTION

The invention relates to a gas-generating pyrotechnic composition, comprising at least:
a reducing agent, 5-aminotetrazole, present in a mass content comprised between 10% and 30%,
an oxidizing agent selected from alkali metal nitrates, alkaline-earth metal nitrates or mixtures thereof, said oxidizing agent being present in a mass content comprised between 30% and 75%, and
an endothermic agent selected from alkali metal oxalates, alkaline-earth metal oxalates, transition metal oxalates or mixtures thereof, said endothermic agent being present in a mass content comprised between 10% and 50%.

Hereinbelow, 5-aminotetrazole will be referred to as 5-AT.

The pyrotechnic composition according to the invention has a satisfactory gas yield during its combustion and maintains a high gas pressure over time because of a reduced generation of condensable species and a limited combustion temperature.

The constituents of this pyrotechnic composition have a limited amount of hydrogen, which reduces the formation of water, which is a condensable species, and a high amount of nitrogen and oxygen, which maintains a satisfactory gas yield. In particular, the 5-AT which forms the reducing agent has a high nitrogen content and a low hydrogen content, thus making it possible to reduce the amount of condensable species generated compared with the use of other agents such as guanidine nitrate, for example. The endothermic agent reduces the combustion temperature of the pyrotechnic composition in order to limit the effects of pressure loss associated with a drop in temperature.

In an example embodiment, the oxidizing agent is selected from strontium nitrate, sodium nitrate or mixtures thereof.

In particular, the oxidizing agent may be strontium nitrate.

Strontium nitrate advantageously avoids any risk of forming caustic species such as NaO or NaOH which may eventually corrode the device in which the pyrotechnic composition is used.

In an example embodiment, the endothermic agent is selected from sodium oxalate, strontium oxalate, copper oxalate or mixtures thereof.

These endothermic agents can be chosen to further reduce the combustion temperature of the pyrotechnic composition and thus to further promote the maintenance of a high gas pressure over time.

In particular, the endothermic agent may be sodium oxalate.

Sodium oxalate has a particularly high endothermic power and thus lowers the combustion temperature of the pyrotechnic composition.

In an example embodiment, said composition further comprises an agglomerating agent present in a mass content comprised between 1% and 6%.

The use of an agglomerating agent, also referred to as a “slagging agent” in the literature, helps to agglomerate the residues generated during combustion and to retain them. In particular, this avoids any risk that the diffusion of combustion residues will disrupt the process and simplifies the solution by making the use of a filter superfluous.

The agglomerating agent is distinct from each of the reducing agent, the oxidizing agent and the endothermic agent. The agglomerating agent may be selected from alumina, an inorganic titanate or mixtures thereof.

In an example embodiment, the pyrotechnic composition is such that:
the reducing agent is present in a mass content comprised between 10% and 25%,
the oxidizing agent is present in a mass content comprised between 35% and 55%, and
the endothermic agent is present in a mass content comprised between 30% and 50%.

The presence of the various constituents in these contents advantageously further improves the compromise between obtaining a high gas yield and maintaining the pressure of the gas generated overtime.

The pyrotechnic composition may be in a variety of forms, for example in the form of an array of grains or pellets, or a monolithic block.

The invention also relates to a gas generator comprising a gas-generating pyrotechnic composition as described above, and an initiator capable of initiating combustion of said composition.

The invention also relates to an inflation device comprising a gas generator as described above and an object to be inflated defining an interior volume in communication with an outlet of the gas generator.

The object to be inflated may be a cushioning pad to protect vehicle occupants. Alternatively, the inflatable object may be an inflatable emergency object, such as an inflatable slide for evacuating passengers from an aircraft.

The invention also relates to a fire extinguisher comprising a gas generator as described above and a body containing an extinguishing agent, the gas generator being adapted to pressurize the extinguishing agent so as to cause it to be dispensed from the body.

The fire extinguisher may comprise a piston configured to move under the effect of the gas generated as a result of the combustion of the pyrotechnic composition and thereby pressurize the extinguishing agent to trigger its dispensing. Alternatively, the generated gas may bubble into the extinguishing agent and thereby trigger its pressurization and dispensing.

### DESCRIPTION OF THE EMBODIMENTS

The inventors have evaluated the thermodynamic characteristics of various pyrotechnic compositions using the Ophelia calculation code. The formulations of the evaluated pyrotechnic compositions and the associated results are provided in the table below.

TABLE 1

| Ingredients | | Ex.1 | Ex.2 | Ex.3 | Ex.4 | Ex.5 |
|---|---|---|---|---|---|---|
| 5AT | % | 28.7 | 20.07 | 17.2 | 16.3 | 15.7 |
| S [symbol] (NO3)2 | % | 71.3 | 49.93 | 42.8 | 42.7 | 41.3 |
| Na2(C2O4) | % | / | 30 | 40 | 40 | 40 |
| Alumina | % | / | / | / | 1 | 3 |
| Thermodynamic characteristics | | | | | | |
| Combustion temperature at 20 MPa | K | 2098 | 1769 | 1686 | 1623 | 1 [symbol] 86 |
| Gas yield at 1 bar and 298K | mole/kg | 18.3 | 13.94 | 12.4 [symbol] 4 | 12.286 | 11.920 |
| Particle rate at 298K | % | 43 | 53.78 | 57.36 | 58. [symbol] 42 | 59.186 |
| Density | g/cm3 | 2.279 | 2.294 | 2.300 | 2.322 | 2.343 |
| Gas yield by volume | mole/ [symbol] | 41.7 | 32.0 | 28.7 | 28.5 | 27.9 |
| Oxygen balance | % | 8.1 | 2.1 | 0.1 | 0.6 | 0.5 |
| Gas phase molar concentration at 1 bar - 298K | | | | | | |
| CO2 | ppm | 184601 | 329971 | 400750 | 398927 | 4052 [symbol] 9 |
| H2O | ppm | 30792 | 30792 | 30792 | 30792 | 30792 |
| N2 | ppm | 646117 | 532581 | [symbol] 66445 | 554125 | 550809 |
| O2 | ppm | 138489 | 46655 | 2011 | 16153 | 13131 |
| total | ppm | 9 [symbol] 9999 | 999 [symbol] 9 | 99 [symbol] 998 | 9 [symbol] 9997 | 1000000 |
| Non-condensable gas rate | % | 96.9 | 96.9 | 96.9 | 96.9 | 96.9 |
| % condensable H2O | % | 2.0 | 1.3 | 1.1 | 1.8 | 1.6 |
| % N2 | % | 64.6 | 59.3 | 56.6 | 55.4 | 55.1 |

[symbol]

indicates data missing or illegible when filed

The composition according to Example 1 corresponds to a composition outside the invention. The compositions of Examples 2 to 5 correspond to compositions according to the invention. The compositions according to the invention have a lower condensable H₂O content and a lower combustion temperature than the composition of Example 1, while maintaining a satisfactory gas yield.

The expression “comprised between . . . and . . . ” should be understood to include the bounds.

1. A gas-generating pyrotechnic composition, comprising:
a reducing agent, 5-aminotetrazole, present in a mass content comprised between 10% and 30%,
an oxidizing agent comprising alkali metal nitrates, alkaline-earth metal nitrates or mixtures thereof, said oxidizing agent being present in a mass content comprised between 30% and 75%, and
an endothermic agent comprising sodium oxalate, strontium oxalate, copper oxalate or mixtures thereof, said endothermic agent being present in a mass content comprised between 10% and 50%.

2. The composition as claimed in claim 1, wherein the oxidizing agent comprises strontium nitrate, sodium nitrate or mixtures thereof.

3. The composition as claimed in claim 2, wherein the oxidizing agent comprises strontium nitrate.

4. The composition as claimed in claim 1, wherein the endothermic agent comprises sodium oxalate.

5. The composition as claimed in claim 1, said composition further comprising an agglomerating agent present in a mass content comprised between 1% and 6%.

6. The composition as claimed in claim 1, wherein:
the reducing agent is present in a mass content comprised between 10% and 25%,
the oxidizing agent is present in a mass content comprised between 35% and 55%, and
the endothermic agent is present in a mass content comprised between 30% and 50%.

7. A gas generator comprising a gas-generating pyrotechnic composition as claimed in claim 1, and an initiator capable of initiating combustion of said composition.

8. An inflation device comprising a gas generator as claimed in claim 7 and an object to be inflated defining an interior volume in communication with an outlet of the gas generator.

9. A fire extinguisher comprising a gas generator as claimed in claim 7 and a body containing an extinguishing agent, the gas generator being adapted to pressurize the extinguishing agent so as to cause the extinguishing agent to be dispensed from the body.
